(19) United States
(12) Patent Application Publication
(10) Pub. No.: US 2022/0292843 A1
(43) Pub. Date: Sep. 15, 2022

(54) SYSTEM AND METHOD FOR IDENTIFYING TRANSPORTATION INFRASTRUCTURE OBJECT VIA CATALOG RETRIEVAL

(71) Applicant: Allvision IO, Inc., Pittsburgh, PA (US)

(72) Inventors: Seth Christian Koterba, Valrico, FL (US); Sree Ramya Surya Prabha Malladi, Pittsburgh, PA (US); Ryan Wynn Frenz, Pittsburgh, PA (US)

(21) Appl. No.: 17/654,202

(22) Filed: Mar. 9, 2022

Related U.S. Application Data
(60) Provisional application No. 63/159,031, filed on Mar. 10, 2021.

(51) Int. Cl. G06V 20/58; G06V 20/40; G06F 16/583

(52) U.S. Cl. CPC G06V 20/582; G06V 20/41; G06F 16/583

(57) ABSTRACT

This patent document describes an object identification system that includes a novel fusion of image capture, image search and a human-in-the-loop reinforcement system. While some disclosed embodiments address the use of the system for identification of a roadway object, the described object identification system can be used for different types of computer vision-related applications.

### RELATED APPLICATION AND CLAIM OF PRIORITY

This patent document claims priority to U.S. patent application No. 63/159,031, filed Mar. 10, 2021, the disclosure of which is fully incorporated into this document by reference.

### BACKGROUND

This patent document describes a system and method for finding the best object match in an object catalog given a set of one or more input images of an unknown object. The system and method are particularly useful in transportation maintenance and related infrastructure control operations, in which operators must maintain and understand the condition of a wide variety of road signs that are dispersed around an area. The system and method also may have other applications as will be described below.

The creation and maintenance of accurate datasets is required for the operation of many modern systems. Autonomous vehicles and navigation systems rely on an accurate dataset of map data that includes not only locations of streets and roads, but also locations and content of traffic control signs such as street signs, speed limit signs and directional signs. In addition, state and municipal road maintenance agencies, and contractors who work for them, rely on such datasets to track and maintain roads, signs, traffic signals and other components of transportation infrastructure in order to enable safer, more efficient driving conditions in the geographic areas for which they are responsible. Further, automated manufacturing and warehouse systems require on accurate identifications of objects in inventory, as well as signage that identifies parts stored in a particular bin location.

Systems that use computer vision to identify and classify objects are commonly used to create datasets such as those described above. However, current systems still have their limitations. For example, some computer vision systems can classify objects but lack the ability to provide other information that is critical to modern systems, such as information about the condition of the object. In addition, many computer vision systems have difficulty distinguishing similar objects from each other (such as street signs that have similar shapes, but different content printed on them, utility poles from various utilities, or different species of trees). Others may categorize dissimilar-looking objects as different objects, even though they fall into the same class (such as an older style of street sign vs. a newer style of street sign).

This document describes methods and systems that address the issues described above, and/or other issues.

### SUMMARY

This patent document presents a novel system and method for matching an object (such as a street sign) observed in one or more images to a specific object in a fixed catalog of known objects (such as a database of street signs and their locations in a geographic area). The system leverages relative scoring of catalog objects and a weighted majority algorithm to combine multiple observations to generate a final match hypothesis and associated confidence metric. The confidence metric is then used to either accept the hypothesis, or refine it via a human-in-the-loop interface. Human refinements may then be used as feedback to expand the catalog, increasing system performance accordingly.

In various system, method and computer program embodiments described in more detail below, a system includes or has access to a data store comprising a catalog of images of known objects such as road signs and other transportation infrastructure objects. In the catalog, the images include a plurality of views for at least some of the known objects. The catalog also includes, for each known object, a feature vector that represents features from one or more views of the known object. When the system receives input images that include various views of an unknown object (such as a transportation infrastructure object), the system will process the input images to generate a feature vector for the unknown object. The system will compare the feature vector for the unknown object to the stored feature vectors in the catalog to generate one or more candidate labels for the unknown object. The system will cause a user interface to output an image of the unknown object and at least one of the candidate labels. The system will then select, from the candidate labels, a final label for the unknown object. Optionally, the system may add the input images and the final label to the catalog as a new known object.

In some embodiments, before comparing the feature vector for the unknown object to the stored feature vectors in the catalog to generate one or more candidate labels for the unknown object, the system will analyze the input images to identify a primary color of the unknown object. The system will then filter the catalog to yield a known object catalog subset that excludes images of known objects that do not correspond to the primary color of the unknown object. Then, when comparing the feature vector for the unknown object to the stored feature vectors in the catalog, the system will use the known object catalog subset rather than all known objects in the larger catalog.

In some embodiments, to select the final label for the unknown object the system may accept a candidate object label that a user has accepted via a user interface. Alternatively, if the user selected a different object label via the user interface, the system may select that different object label as the final object label.

In some embodiments, when comparing the feature vector for the unknown object to the stored feature vectors in the catalog, the system may generate a confidence metric for each of the candidate object labels. If so, then when selecting the final label for the unknown object the system may select a known object that is associated with a stored feature vector for which the confidence metric exceeds a threshold.

In some embodiments, when processing the input images to generate the feature vector for the unknown object, the system may generate a matrix of feature values of each of the views of the unknown object. The matrix may have a size of M×F or F×M, in which M is a total number of the views of the input object, and F is a total number of the feature values. Each row or column of the matrix may be a vector of all feature values for one of the images in the catalog of the labeled object, and the matrix may have a number of rows or column equal to the total number of images of the known object.

In some embodiments, when comparing the feature vector for the unknown object to the stored feature vectors in the catalog to generate one or more candidate object labels, the system may generate a distance matrix comprising distances between values in the matrix of feature values and values in the feature vectors for all known objects in the catalog.

In some embodiments, when comparing the feature vector for the unknown object to the stored feature vectors in the catalog to generate one or more candidate object labels, the system may generate a closeness matrix in which each row or column is a vector of closeness values of each view of the input object to a known object in the catalog, and the closeness matrix has a number of rows or columns equal to the number of labeled objects in the catalog.

In some embodiments, to generate the one or more candidate object labels for the unknown object, the system may generate an initial match hypothesis for the unknown object. The initial match hypothesis is a potential match with one of the known objects in the catalog. Then, when the user interfaces outputs at least one of the candidate object labels, the system will display at least display an image of a known object that corresponds to the initial match hypothesis. The system also may display images of a plurality of the known objects that are in a nearest neighbor network of the known object that corresponds to the initial match hypothesis.

### BRIEF DESCRIPTION OF THE DRAWINGS

FIG. 1 is a block diagram of various elements of an image-based object identification system.

FIG. 2 illustrates a method of capturing images of an unknown object at multiple views by an image acquisition system.

FIG. 3 illustrates elements of a catalog that includes one or more images for multiple known objects.

FIG. 4 is a flow diagram of a search process which includes feature extraction and relative scoring algorithms.

FIG. 5 shows a block diagram of a reinforcement system which illustrates a human-in-the-loop interface.

FIG. 6 illustrates an example of images that may remain in a catalog after a color filter has been applied.

FIG. 7 illustrates an example showing feature extraction, using the images of FIG. 6.

FIGS. 8A and 8B illustrate example distance and rank calculations between various input image views and image views of various known objects

FIGS. 9A and 9B illustrate an example showing visualization of computing closeness and matched hypothesis.

FIG. 10 illustrates example hardware components of a computing system that may implement the features described above.

### DETAILED DESCRIPTION

The methods and systems described in this document provide a novel fusion of computer vision, machine learning and human-computer interaction methods to perform a complicated task of matching an unknown object observed in one or more images to a known object in a fixed catalog.

This methods and systems described below can be used to enhance various computer vision-related search applications. For example, the teachings of this disclosure can be particularly useful in applications where redundant observations of an object can be obtained, and the catalog to be searched is known in advance and generally stable. Example applications include: (a) classification of roadway objects such as traffic signs, guard rails, and street lights; (b) wildlife species identification; (c) identification of parts or objects in manufacturing or warehouse inventory; and (d) assessing a condition of any or all of the items described above.

Transportation infrastructure objects are objects that are installed on or near roadways, parking areas and other transportation networks to guide vehicles and their operators along a route. The transportation networks may include networks of roads on which vehicles travel; rail networks for trains, subways and the like; urban transportation networks which include roads and/or sidewalks, bike paths, and other transportation paths; and even networks of defined paths along which robotic devices and/or humans may travel, such as defined paths in a warehouse or other commercial or industrial facility, or a park or other recreational area. Some transportation infrastructure objects may be directional, such as street signs and upcoming exit signs. Other transportation infrastructure objects may and/or to notify the vehicles and their operators of traffic control measures, as with speed limit signs, stop signs, yield signs, and signs indicating that construction or other conditions are ahead along the route. The classification of transportation infrastructure objects, and in particular the problems associated with automated, detailed classification of traffic signs serves as a good example of the applicability of the methods and systems described above. In the United States, traffic signs are classified using a catalog (the Manual on Uniform Traffic Devices, or MUTCD catalog) that is comprised of over 1000 individual records, many of which contain only subtle visual differences. It is critical for safety and maintenance that each physical sign is associated with the correct catalog item. However, most modern approaches to image search (for example, a visual deep learning system based on one or more Convolutional Neural Networks) are not well-suited to this problem due to visual similarities in the catalog and significant variance in real-world input observations. Further, due to the large nature of the catalog, training such a network with sufficient accuracy would require an enormous set of priors (labels) and equivalent manual labor to prepare. As detailed below, this class of problem requires a more integrated approach that leverages visual similarity, confidence/scoring, and human reinforcement when necessary.

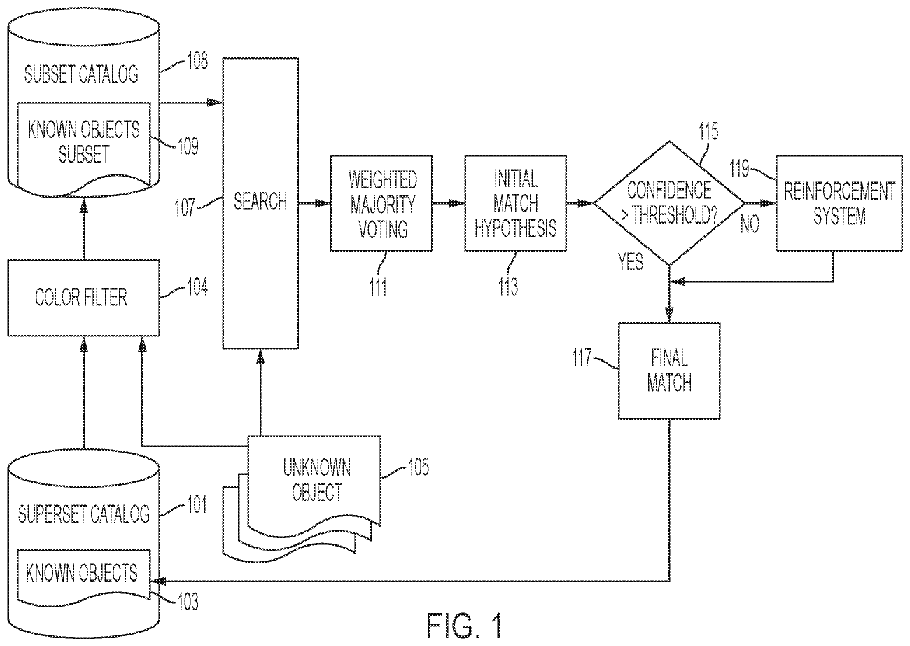

As shown in FIG. 1, a block diagram of an image-based object identification system is presented. A catalog 101 comprising one or more memory devices that store digital images of known objects 103 is part of or available to the system. Known objects such as street signs or traffic signals also may be referred to as “labeled objects”, as the data set will associate a label with each known object image to provide information that enables the object in the image to be known. The catalog will have a finite number of labeled objects 103, such as road signs, wildlife species, or parts or products in an inventory. The catalog 101 will have one or more images of each labeled object 103, and ideally more than one image of each labeled object 103. The system will use this catalog 101 to develop composite feature vectors for each labeled object 103 for which the catalog includes multiple views, as will be described in more detail below. This use of a catalog of multiple views of an object provides advantages over prior art image classification systems.

The catalog 101 of known objects is available to the system. The system will then receive one or more images of an unknown object 105, which may be referred to in this document as an “input object.” The images of the unknown object 105 may represent multiple views of the unknown object. The goal of the system is to retrieve the best match for the unknown object 105 with one of the known objects in the finite sized catalog 101.

Optionally, before performing the match, the system may filter the catalog 101 to reduce the number of images that will be compared in a search function. In such a situation, the complete catalog 101 may be considered to be a superset catalog, and the result of the filtering will be a subset catalog 108 that contains a subset 109 of the known objects that are in the superset catalog. The filtering function may be a color filter 104 that yields a subset catalog 108 with a known objects subset 109 that includes only known objects having a primary color that corresponds to (i.e., matches or is similar to) the dominant color of the unknown input object 105. This can be especially useful in applications such as transportation infrastructure, as traffic control signs typically have a dominant color (for example, stop signs are predominantly red, many speed limit signs are predominantly white, and signs that provide cautionary information about potential road hazards ahead are predominantly yellow). The resulting subset catalog 108 will have fewer data points than the superset catalog 101 and therefore may be searched more quickly in the search function 107, which will be described in the following paragraph.

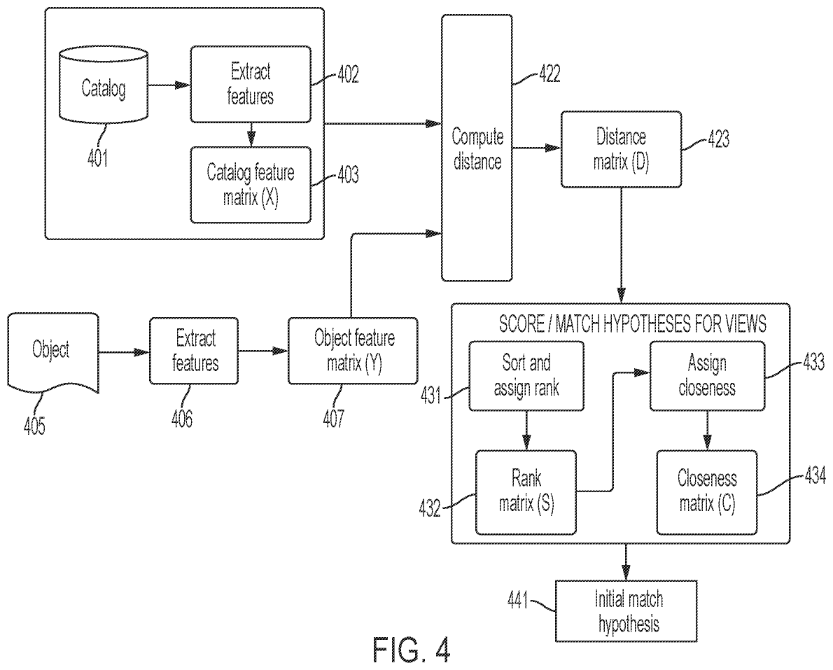

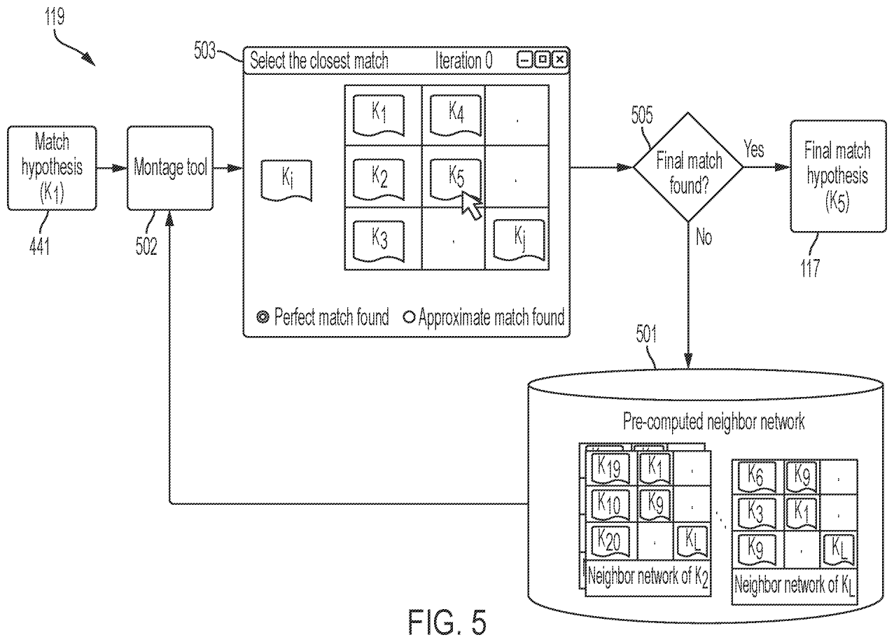

A system comprising a processor and a memory containing programming instruction applies a search function 107 to the input object (unknown object 105) and the catalog of known objects. At this step, the system may apply the search function to the subset catalog 108 as shown in FIG. 1 (and as will be described by way of example in the following paragraph), or it may apply the search function to the superset catalog 105 if the filter function was not used. The search function 107 will be described in more detail with reference to FIG. 4. However, at a high level, the search function 107 uses a relative scoring algorithm and outputs a closeness value for each view of the unknown object 105 to some or all known objects in the catalog (101 or 108). The system uses a weighted majority voting algorithm 111 (also described in more detail in the discussion of FIG. 4) to generate an initial match hypothesis 113 for the unknown object 105 with respect to a known object from the catalog of known objects. The majority voting algorithm 111 will also yield a confidence metric for the initial match hypothesis 113. If the confidence metric exceeds a threshold (115: YES), the system will consider the initial match hypothesis to be the final match 117. If the confidence metric does not exceed the threshold (115: NO), the system will send the initial match hypothesis and object images to a reinforcement system 119, which is a user interface via that displays those items to a human-in-the-loop, and via by which the human user may either (a) accept the initial match hypothesis 113 to be the final match 117, or (b) enter a final match 117 that identifies the object 105 as something other than the initial match hypothesis 113. An example reinforcement system 119 will be described in more detail below in the discussion of FIG. 5. The system also may add the input images 105, along with the final assigned object label (i.e., the final match 117) to the catalog 101 as another known object 103 for use in future object classification processes.

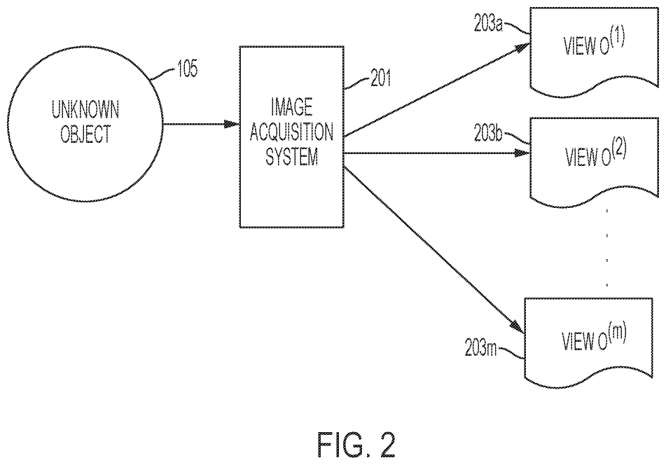

As shown in FIG. 2, to obtain the images of the unknown object 105, an image acquisition system 201 will include one or more cameras that capture any number of different views of the unknown object 203a . . . 203m. The captured object is represented as a set of images:

O={o⁽¹⁾,o⁽²⁾, . . . ,o(m)} (1)

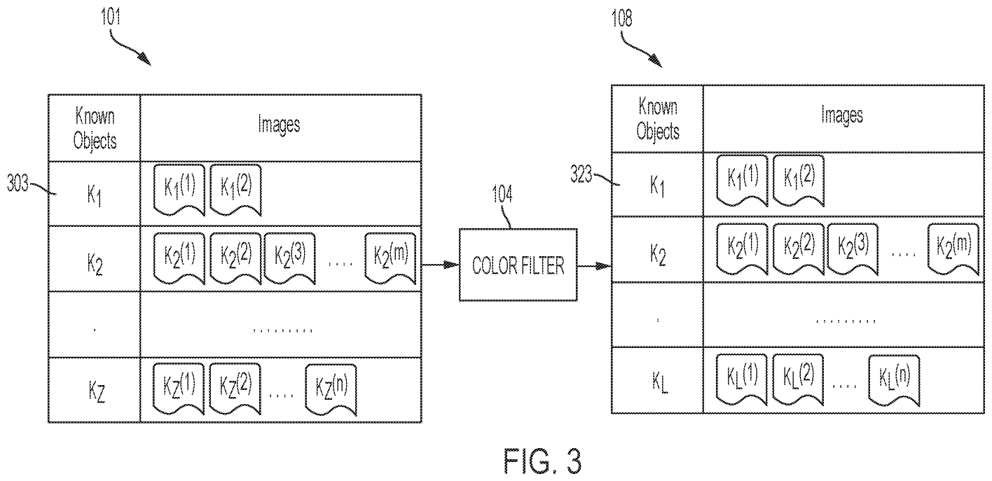

As shown in FIG. 3, consider a superset catalog (K) 101 to include catalog items Kᵢ 303, each of which includes a label and images for each object in a set of known objects (103 in FIG. 1) denoted as:

K={K₁,K₂, . . . ,K_{z}} (2)

Each known object's catalog item Kᵢ, 303 in the superset catalog 101 will include or be associated with one or more images of the known object denoted as:

Kᵢ={kᵢ⁽¹⁾,kᵢ⁽²⁾, . . . ,kᵢ⁽ⁿ⁾} (3)

where kᵢ^{(J)} is the j^{th} image belonging to the i^{th} known object, K.

As noted above in the discussion of FIG. 1, the system may use a color filter 104 to select a subset of known objects from the superset catalog 101. This is illustrated in more detail in FIG. 3, where the superset catalog 101 is filtered to yield a subset catalog 108. In an example filtering process, for all the images of each unknown object (105 from FIG. 1), three dominant colors are computed and mapped to one of any number of reference colors. By way of example, the reference colors may include black (0, 0, 0), blue (0, 0, 255), green (0, 255, 0), red (255, 0, 0), pink (255, 0, 128), orange (255, 128, 0), yellow (255, 255, 0) and white (255, 255, 255). Similarly, three dominant colors are computed for all the images in the superset catalog 101. Here black (0, 0, 0) represents the color name and red-green-blue (RGB) values. The system will select initial subset of L known objects are selected to form a subset catalog 108 that includes a subset of catalog item Kᵢ 323 in which all of the subset catalog items Kᵢ 323 have a dominant color that matches the dominant color of the unknown object:

K={K₁,K₂, . . . ,K_{L}} (4)

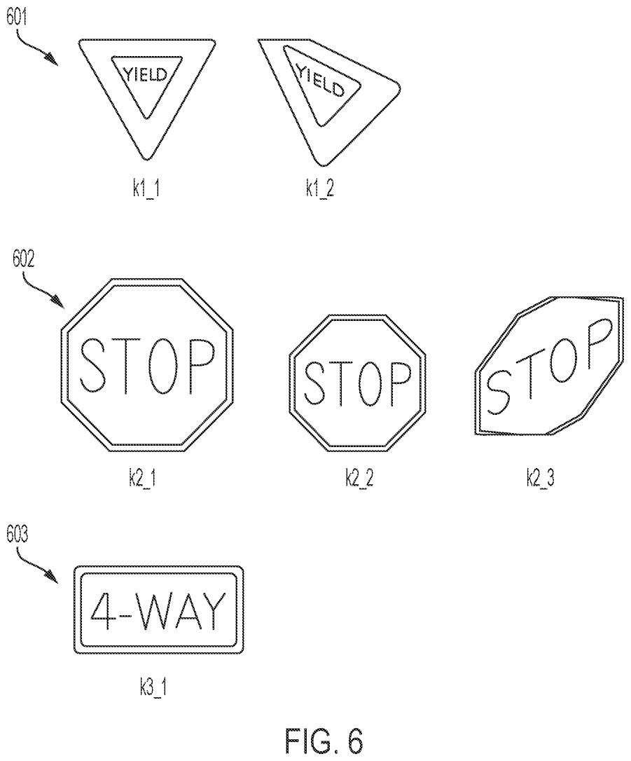

Images from an example subset catalog are shown in FIG. 6, in which a catalog contains images of street signs having a primary color of red. These include multiple views of a yield sign K₁ 601, multiple views of a stop sign K₂ 602, and a single view of a 4-way sign K₃ 603.

FIG. 4 illustrates an example process that the search system (107 in FIG. 1) may follow when an unknown object 405 is input to the search system. A catalog 401, which as noted above in the discussion of FIG. 1 may be a superset catalog 101 or a subset catalog 108, of known objects will be available to the search system. The search system may access and query the catalog 401, or the search system or another system may pre-process the catalog by extracting features 402 of known objects and using the extracted features 402 generating a feature matrix 403 (X) for the catalog. The catalog feature matrix 403, when available, may be pre-computed and/or updated using a feature extraction algorithm. Possible feature extraction algorithms include, without limitation: (i) the Canny edge detection algorithm; (ii) algorithms described by Lindeberg in “Edge Detection and Ridge Detection with Automatic Scale Selection”, International Journal of Computer Vision, 30(2), pp. 117-156 (1988); (iii) corner feature extraction and computing algorithms described by Harris and Stephens in “A Combined Corner and Edge Detector” (Plessey Research Roke Manor, 1988); (iv) algorithms for extracting texture features, generally known as Gabor filters, as described for example by Haghighat et al in “Identification Using Encrypted Biometrics”, International Conference on Computer Analysis of Images and Patterns, pp. 440-448 (August 2013). Springer, Berlin, Heidelberg); (v) custom features developed through deep learning frameworks such as VGG16 (as described in Simonyan et al., “Very Deep Convolutional Networks for Large-Scale Image Recognition”, arXiv:1409.1556 (2014); and (vi) Inception-v2, as described by Szegedy et al. in “Inception-v4, Inception-ResNet and the Impact of Residual Connections on Learning, arXiv:1602.07261v2 (2016). Using the feature extraction algorithm, the system computes a set of features 402 for each individual image under consideration and is not limited to any particular features. Features may include conventional image features based on edge, corner, shape, and/or color, using algorithms such as (i)-(iv) above. Alternatively, custom features developed through deep learning frameworks may also be used, using algorithms such as (v) and (vi) above.

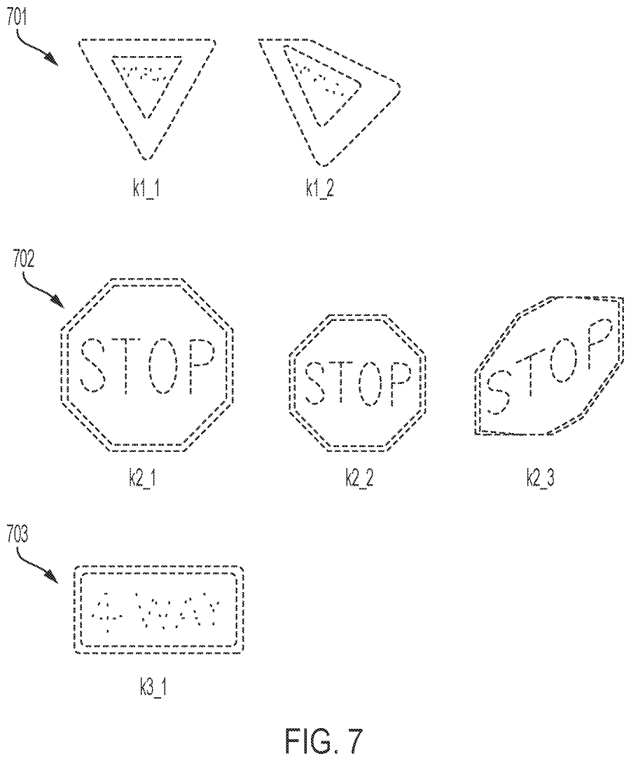

X is a catalog feature matrix 403 containing all the feature values of all observations of the known objects in the catalog:

$$X = [ \begin{matrix}{x}_{1}^{( 1 )} & … & {x}_{F}^{( 1 )} \\ ⋮ & ⋱ & ⋮ \\ {x}_{1}^{( T )} & … & {x}_{F}^{( T )}\end{matrix} ] \qquad ( 5 )$$

where [x₁, . . . , x_{F}⁽ⁱ⁾] is a vector of all feature values of the iₜₕ observation in the collection of known object observations, F is the total number of feature values, T=Σ_{I=1}^{L}K̅ₜ, where K̅ₜ represents the number of observations of the i^{th} known object and L is the total number of known objects. An example showing the feature extraction is shown in FIGS. 6 and 7, in which FIG. 6 illustrates several images of known objects that are in an example catalog, and FIG. 7 shows a visual representation of features that may be extracted for each of the individual images in the catalog.

Returning to FIG. 4, the search system also will extract features 406 from the image or images of the unknown object 405, and it will use the extracted features 406 to generate an object feature matrix 407 (Y) for the object, in which matrix Y 407 contains all of the feature values of all the captured views of the unknown object 405. The size of the object feature matrix 407 is M×F, where M is the total number of captured views of the unknown object 405 and F is the total number of feature values 406:

$$Y = [ \begin{matrix}{y}_{1}^{( 1 )} & … & {y}_{F}^{( 1 )} \\ ⋮ & ⋱ & ⋮ \\ {y}_{1}^{( M )} & … & {y}_{F}^{M}\end{matrix} ] \qquad ( 6 )$$

where [y₁⁽ⁱ⁾, . . . , y_{F}^{(j)}] is a vector of all feature values of the j^{th} observation of a detected object, o^{(j)}. (Note: the data contained in rows M and columns F of the matrix may be reversed, so that the data is arranged is F×M.) FIG. 7 illustrates an example visualization of feature extraction applied to the image subset of FIG. 1, with a visual representation of features extracted for each such view of each object, normalized to so that the images are a substantially consistent size. In FIG. 7, features are shown as extracted from multiple views of yield sign k₁ 701, multiple views of a stop sign k₂ 702, and a single view of a 4-way sign k₃ 703.

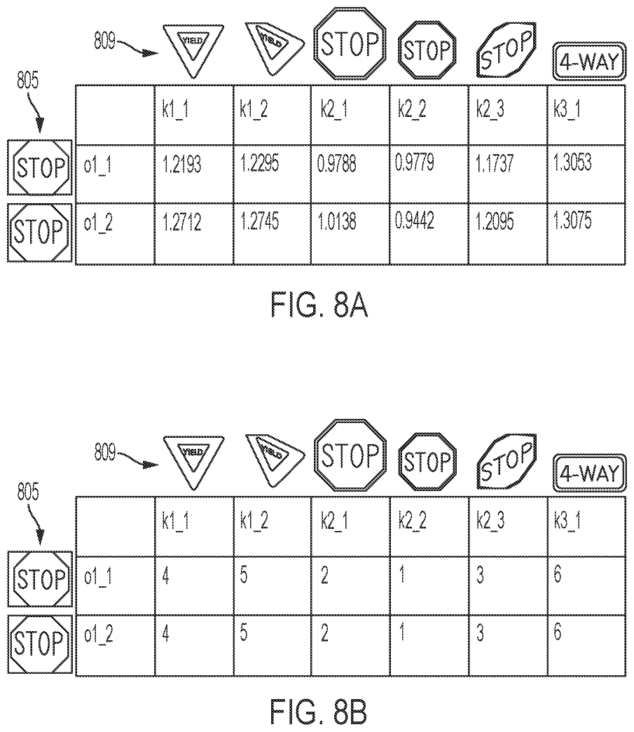

Returning to FIG. 4, the search system will also compute a distance matrix 423 (D) representing a distance between the catalog feature matrix 411 and the object feature matrix 415:

$$D = [ \begin{matrix}{d}_{1}^{( 1 )} & … & {d}_{T}^{( 1 )} \\ ⋮ & ⋱ & ⋮ \\ {d}_{1}^{( M )} & … & {d}_{T}^{( M )}\end{matrix} ] \qquad ( 7 )$$

where each [d₁^{(j)}, . . . , d_{T}^{(j)}] is a computed distance vector 422 of all feature values of the j^{th} view of the unknown object 105, o^{(j)}, to all T views of the known objects in the catalog 101. The system may determine each distance vector as the Euclidean distance between the feature vectors from the catalog feature matrix 411 and the object feature matrix 415. FIG. 8A illustrates an example matrix of Euclidean distance calculations between two views of an input object 805 that is a stop sign, and various views of known objects 809 from a subset catalog of objects having a primary color corresponding to the primary color of a stop sign. Euclidean distance values between various views of the input object 805 and various views of known objects 809 are shown in the matrix. As can be seen, images of known objects that are stop signs have the shortest Euclidean distances to the input object images. The input images are relatively more distant from the views of other objects in the catalog. Other distance calculation methods may be used in various embodiments.

Each row of the distance matrix 423 corresponds to the j^{th} view of the unknown object 105, o^{(j)}. To generate an initial match hypothesis, for each j^{th} view of the unknown object 105, o^{(j)}, At 431 the system will first sort distances, from closest to farthest, to all T images in the catalog. At 431 the system will also assign a rank to each j^{th} view based on the sorted distances, in which the highest rank is that which corresponds to the smallest distance. This is shown by way of example in FIG. 8B, where the input images have the shortest Euclidean distance to (and are thus closest to) known object image k₂⁽²⁾, which the catalog labels as a stop sign. Therefore, the highest rank of 1 is given to known object image k₂⁽²⁾. Known object images k₂⁽¹⁾ and k₂⁽³⁾ are also stop signs, but with different views that result in higher distance values. Thus, those images are assigned ranks 2 and 3, respectively. Known object images for a yield sign (k₁⁽¹⁾ and k₁⁽²⁾ and a 4-way sign (k₃⁽¹⁾ are even more distant from the input images and thus are assigned lower rankings, with the 4-way sign image (k₃⁽¹⁾ receiving the lowest rank because it is the most distant from the input object images.

The rank vector for each known object Kᵢ in the catalog corresponding to the j^{th} view of the unknown object, o^{(j)}, is defined as:

R_{Ki}^{j}=[rᵢ⁽¹⁾,Rᵢ⁽²⁾, . . . ,rᵢ⁽ⁿ⁾] (8)

where n is the total of number images belonging to the known object Kᵢ and rᵢ^{(*)} ∈ {1, 2, . . . , T}.

Each known object Kᵢ in the catalog is assigned a rank of:

sᵢ^{j}=min(Rₖᵢ^{j}) (9)

where Rₖᵢ^{j} is obtained as in equation (8).

The final sorted matrix 432 (S) for L known objects in the catalog is represented as:

$$S = [ \begin{matrix}{s}_{1}^{( 1 )} & … & {s}_{L}^{( 1 )} \\ ⋮ & ⋱ & ⋮ \\ {s}_{1}^{( M )} & … & {s}_{L}^{M}\end{matrix} ] \qquad ( 10 )$$

where [s₁^{(j}, . . . , s_{L}^{(j)}] is a vector of all sorted values of the j^{th} view of the unknown object 105, o^{(j)}), to all L known objects in the catalog 101.

Finally, at 433 the system will assign closeness values for each view of the unknown object 405 to the L known objects in the catalog 401. The closeness values may be a sorted, normalized rank value for each view with respect to the known object in the catalog. The system will thus output of a closeness matrix 434 (C):

$$C = [ \begin{matrix}{c}_{1}^{( 1 )} & … & {c}_{L}^{( 1 )} \\ ⋮ & ⋱ & ⋮ \\ {c}_{1}^{( M )} & … & {c}_{L}^{M}\end{matrix} ] \qquad ( 11 )$$

where [c₁^{(j)}, . . . , c_{L}^{(j)}] is a vector of closeness values of the j^{th} view of the unknown object, o^{(j)}, to the L known objects in the catalog, each closeness value

$${c}^{( j )} = 1 - ( \frac{{s}^{( j )}}{L} ) ,$$

and the range of closeness values c^{(j)}∈[0, 1].

The system will then use the closeness matrix 434 (C) to generate a match hypothesis H for each view of the unknown object:

$$H = [ \begin{matrix}{h}^{( 1 )} \\ ⋮ \\ {h}^{( M )}\end{matrix} ] \qquad ( 12 )$$

where the match hypothesis for the j^{th} view of the unknown object 405 o^{(j)} is a known object Kᵢ in the catalog 401 if cᵢ^{(j)}≥T and T ∈ [0, 1].

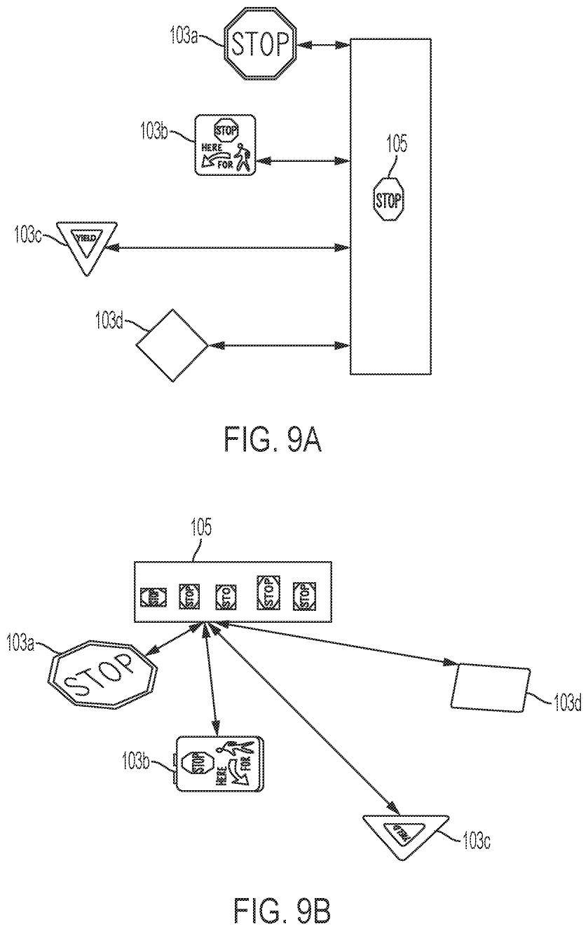

FIG. 9A illustrates an example visualization of measures of closeness between one view of an unknown object 105 and various known objects 103a . . . 103d in a catalog, in which a double-arrowed line represents the measure of closeness in each instance. In this example, unknown object 105 is a stop sign. First known object 103a has features matching that of a stop sign and no additional features, so the line between first known object 103a and unknown object 105 is the shortest, representing the most closeness (i.e., the shortest distance) of the candidate known objects 103a . . . 103d. Second known object 103b has the next most closeness as it contains the features of a stop sign, but it also has other features that are not part of a stop sign. Third known object 103c and fourth known object 103d are even further from unknown object as they do not contain features of a stop sign, and as between the fourth known object 103d is relatively closer than third known object 103c because the fourth known object 103d has a number of sides feature of that is relatively closer to that feature of the unknown object 105.

FIG. 9B shows a visualization of closeness in which the system has multiple views of the unknown object 105, and in each case each view of the unknown object is closer to known object 103a (the stop sign) than it is to any of the other unknown objects 103b-103d.

Finally, referring again to FIG. 4, a weighted majority voting function, ν( ), is a way that the system may combine the match hypothesis of each view of the unknown object 105 (O) to an initial match hypothesis 441 for the unknown object 105. While this can be accomplished in different ways, one possible way of computing the initial match hypothesis of the unknown object 105 (O) with respect to objects of the catalog 101 (K) using the weighted majority voting function ν( ) is:

$${V ( H )}^{=} {h}^{( j )} , if \frac{1}{M} ( {\sum }_{M = 1}^{M} {c}_{i}^{( m )} ) \geq T \qquad ( 13 )$$

where h^{(j)} is the hypothesis corresponding to the j^{th} view of the unknown object 105, o^{(j)}, cᵢ^{(m)} is the closeness value between the known object Kᵢ in the catalog 101 and the m^{u}′ view of the unknown object 105 O^{(m)}, and T ∈ [0,1].

Referring back to FIG. 1, the majority voting function 111 will also yield a confidence metric for the initial match hypothesis, which the system may calculate as:

$$confidence metric = \frac{1}{M} ( {\sum }_{M = 1}^{M} Q ( {o}^{m} ) ) , \qquad ( 14 )$$

where Q(.) is a quality function. The quality function may include calculating the pixel area, brightness, contrast or no reference image quality measures such as those described in Mittal et al., “No-Reference Image Quality Assessment in the Spatial Domain”, IEEE Transactions on Image Processing (2012). In the confidence metric equation above, o^{(m)} is the m^{th} view of the unknown object 105, and M is the total number of views that correspond to the unknown object 105.

If the confidence metric exceeds a threshold (115: YES), the system will consider the initial match hypothesis to be the final match 117. If the confidence metric does not exceed the threshold (115: NO), the system will send the initial match hypothesis and object images to a reinforcement system 119. FIG. 5 illustrates example components of the reinforcement system 119, which may include components such as:

A pre-computed neighbor network 501: Prior to receiving a new image of an object for analysis, the system will develop or receive a nearest neighbor network 501. In particular, for each known object in the catalog, a neighbor network with closest G match hypothesis (neighbors) within the catalog is computed through the search process described in the context of FIG. 4 paragraphs above considering the known object as an unknown object.

A graphic user interface (UI) 503, which may be generated by a processor executing programming instructions referred to in this document as the “montage tool” 502, for displaying (a) an observation of the input object, (b) a view of the match hypothesis and a view of its G closest neighbors based on the neighbor network that was generated as described above. The montage tool 502 generates a user interface 503 showing one or more of the system's hypotheses—i.e., the most likely potential match or matches, with the number of possibilities presented selected based on any suitable criteria such as (i) the n matches having the highest confidence values, (ii) all matches having a confidence value exceeding a threshold, (iii) some combination of these, or using other criteria. In the first iteration, the match hypothesis is the result of the search algorithm, but in subsequent iterations the match hypothesis is manually selected from the G closest neighbors. The user interface may display an image of a known object that corresponds to the initial match hypothesis, along with images of known objects that are in the nearest neighbor network of the known object that corresponds to the initial match hypothesis.

This tool allows user input to either select one of the matches or nearest neighbors (505: YES) as the final match 117, and thus completing the object identification process. Or, a user of the reinforcement system 119 may identify a match as the best approximate match (505: NO), which triggers another iteration of the reinforcement system, based on that approximate match.

As described above, an image-based object identification system may include:

a finite-sized catalog comprising a memory storing one or more images for each known object;

one or more images of an observed object, consisting of one or more images of the object;

a memory containing programming instructions that are configured to cause a processor to execute:

(1) a feature extraction algorithm which generates feature vectors for all observed images and all catalog images;

(2) a relative scoring algorithm which generates one or more object hypotheses for an input image based on the closest matches between the image's feature vector and the feature vectors of the catalog images; and

(3) a weighted majority algorithm which combines the object hypotheses from one or more images of the same input object to find a final object hypothesis for the input object.

Applications of the process above may include a system having a finite set of known objects, so that the system can receive a new object and quickly attempt to match it to one of the known objects in the catalog.

The programming instructions will also cause the processor to generate a confidence metric for accepting the final hypothesis or requesting human intervention.

The processor will then cause a display device of the system to output a component of a visual UI for displaying the input object, the final object hypothesis and the closest catalog objects of the final object hypothesis.

The UI will also include user input mechanisms for a human operator to:

(a) choose a new object hypothesis from the objects shown in the UI;

(b) request a display update using the new object hypothesis; and

(c) finalize the object assignment based on one of the currently displayed objects.

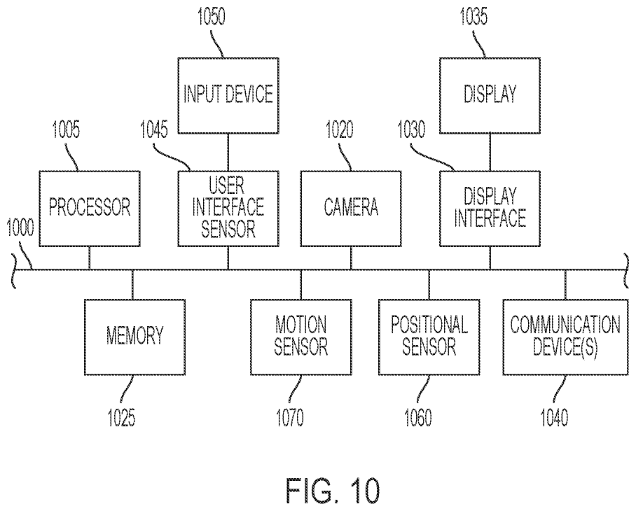

FIG. 10 depicts an example of internal hardware that may be included in any of the electronic components of the system, such as the catalog 101, the system that searches (107) the catalog and develops match hypothesis for unknown objects, the image acquisition system 201, the reinforcement system 119 in which a human reviews match hypotheses, or any other local or remote computing device in the system. An electrical bus 1000 serves as an information highway interconnecting the other illustrated components of the hardware. Processor 1005 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 1025. A memory device may include a single device or a collection of devices across which data and/or instructions are stored. Some segments of a memory device may store the image catalog; other segments of the same or a different memory device may store programming instructions that are configured to, when executed, cause a processor to perform the functions described in this document.

An optional display interface 1030 may permit information from the bus 1000 to be displayed on a display device 1035 in visual, graphic or alphanumeric format. The display device may serve as a user interface of the reinforcement system 119 of FIG. 1. An audio interface and audio output (such as a speaker) also may be provided. Communication with external devices may occur using various communication devices 1040 such as a wireless antenna, an RFID tag and/or short-range or near-field communication transceiver, each of which may optionally communicatively connect with other components of the device via one or more communication system. The communication device 1040 may be configured to be communicatively connected to a communications network, such as the Internet, a local area network or a cellular telephone data network.

The hardware may also include a user interface sensor 1045 that allows for receipt of data from user interface input devices 1050 such as a keyboard, a mouse, a joystick, a touchscreen, a touch pad, a remote control, a pointing device and/or microphone. Digital image frames also may be received from a camera 1020 (which may be a component of image acquisition system 201 of FIG. 2) or another imaging device that can capture video and/or still images. The system also may include a positional sensor 1080 and/or motion sensor 1070 to detect position and movement of the device. Examples of motion sensors 1070 include gyroscopes or accelerometers. Examples of positional sensors 1080 include a global positioning system (GPS) sensor device that receives positional data from an external GPS network.

Terminology that is relevant to this disclosure includes:

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 10.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data storage facility”, and the like each refer to a non-transitory device on which computer-readable data, programming instructions or both are stored. The terms “catalog” and “data store” refer to memory device and data together. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

In this document, the term “imaging device” refers generally to a hardware sensor that is configured to acquire digital images. An imaging device may capture still and/or video images for inclusion in the image catalog described in the disclosure above. For example, an imaging device can be held by a user such as a DSLR (digital single lens reflex) camera, cell phone camera, or video camera. The imaging device may be part of an image capturing system that includes other hardware components. For example, an imaging device can be mounted on an accessory such as a monopod or tripod. The imaging device can also be mounted on a transporting vehicle such as an aerial drone, a robotic vehicle, or on a piloted aircraft such as a plane or helicopter having a transceiver that can send captured digital images to, and receive commands from, other components of the system.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.”

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

The features and functions described above, as well as alternatives, may be combined into many other different systems or applications. Various alternatives, modifications, variations or improvements may be made by those skilled in the art, each of which is also intended to be encompassed by the disclosed embodiments.

1. A method of classifying a transportation infrastructure object in a plurality of digital images, the method comprising, by a processor:
acquiring a plurality of input images that include a plurality of views of an unknown object;
processing the input images to generate a feature vector for the unknown object;
accessing a data store that includes a catalog that contains:
images of a plurality of known objects that comprise transportation infrastructure objects, and
for each known object, a feature vector that represents features from one or more views of the known object, and
comparing the feature vector for the unknown object to the stored feature vectors in the catalog to generate one or more candidate labels for the unknown object;
outputting, via a user interface, an image of the unknown object and at least one of the candidate labels; and
selecting, from the candidate labels, a final label for the unknown object.

2. The method of claim 1 further comprising:
before comparing the feature vector for the unknown object to the stored feature vectors in the catalog to generate one or more candidate labels for the unknown object:
analyzing the input images to identify a primary color of the unknown object, and
filtering the catalog to yield a known object catalog subset that excludes images of known objects that do not correspond to the primary color of the unknown object; and
wherein the catalog used when comparing the feature vector for the unknown object to the stored feature vectors in the catalog is the known object catalog subset.

3. The method of claim 1 wherein selecting the final label for the unknown object comprises receiving, via the user interface, a user acceptance of one of the output candidate object labels or a request to apply a different object label to the unknown object.

4. The method of claim 1, further comprising adding the input images and the final label to the catalog as a new known object.

5. The method of claim 1, wherein:
comparing the feature vector for the unknown object to the stored feature vectors in the catalog further comprises generating a confidence metric for each of the candidate object labels; and
selecting the final label for the unknown object comprises selecting a known object that is associated with a stored feature vector for which the confidence metric exceeds a threshold.

6. The method of claim 1, wherein processing the input images to generate the feature vector for the unknown object comprises generating a matrix of feature values of each of the views of the unknown object, wherein:
the matrix has a size of M×F or F×M;
M is a total number of the views of the input object; and
F is a total number of the feature values.

7. The method of claim 6, wherein:
each row or column of the matrix is a vector of all feature values for one of the images in the catalog of the labeled object; and
the matrix has a number of rows or column equal to the total number of images of the known object.

8. The method of claim 1, wherein comparing the feature vector for the unknown object to the stored feature vectors in the catalog to generate one or more candidate object labels comprises:
generating a distance matrix comprising distances between values in the matrix of feature values and values in the feature vectors for all known objects in the catalog.

9. The method of claim 1, wherein comparing the feature vector for the unknown object to the stored feature vectors in the catalog to generate one or more candidate object labels further comprises generating a closeness matrix in which:
each row is a vector of closeness values of each view of the input object to a known object in the catalog; and
the closeness matrix has a number of rows or columns equal to the number of labeled objects in the catalog.

10. The method of claim 1, wherein:
generating the one or more candidate object labels for the unknown object comprises generating an initial match hypothesis for the unknown object, wherein the initial match hypothesis comprises one of the known objects in the catalog; and
outputting, via a user interface, at least one of the candidate object labels comprises:
displaying an image of a known object that corresponds to the initial match hypothesis, and
displaying images of a plurality of the known objects that are in a nearest neighbor network of the known object that corresponds to the initial match hypothesis.

11. A system for classifying an object in a plurality of digital images, the method comprising:
a data store comprising a catalog of:
images of known objects, in which the images include a plurality of views for at least some of the known objects, and
for each known object, a feature vector that represents features from one or more views of the known object;
a processor; and
a memory containing programming instructions that are configured to instruct the processor to, upon receiving a plurality of input images that include a plurality of views of an unknown object:
processing the input images to generate a feature vector for the unknown object,
comparing the feature vector for the unknown object to the stored feature vectors in the catalog to generate one or more candidate labels for the unknown object,
cause a user interface to output an image of the unknown object and at least one of the candidate labels, and
selecting, from the candidate labels, a final label for the unknown object.

12. The system of claim 11, further comprising programming instructions to:
before comparing the feature vector for the unknown object to the stored feature vectors in the catalog to generate one or more candidate labels for the unknown object:
analyze the input images to identify a primary color of the unknown object, and
filter the catalog to yield a known object catalog subset that excludes images of known objects that do not correspond to the primary color of the unknown object; and
when comparing the feature vector for the unknown object to the stored feature vectors in the catalog, use the known object catalog subset instead of all known objects in the catalog.

13. The system of claim 11, wherein the instructions to select the final label for the unknown object comprise instructions to select either a user-accepted output candidate object label as received via a user interface or different object label as received via the user interface.

14. The system of claim 11, further comprising additional instructions to add the input images and the final label to the catalog as a new known object.

15. The system of claim 11, wherein:
the instructions to compare the feature vector for the unknown object to the stored feature vectors in the catalog further comprise instructions to generate a confidence metric for each of the candidate object labels; and
the instructions to select the final label for the unknown object comprise instructions to select a known object that is associated with a stored feature vector for which the confidence metric exceeds a threshold.

16. The system of claim 11, wherein the instructions to process the input images to generate the feature vector for the unknown object comprise instructions to generate a matrix of feature values of each of the views of the unknown object, wherein:
the matrix has a size of M×F or F×M;
M is a total number of the views of the input object; and
F is a total number of the feature values.

17. The system of claim 16, wherein:
each row or column of the matrix is a vector of all feature values for one of the images in the catalog of the labeled object; and
the matrix has a number of rows or column equal to the total number of images of the known object.

18. The system of claim 11, wherein the instructions to compare the feature vector for the unknown object to the stored feature vectors in the catalog to generate one or more candidate object labels comprise instructions to:
generate a distance matrix comprising distances between values in the matrix of feature values and values in the feature vectors for all known objects in the catalog.

19. The system of claim 11, wherein the instructions to compare the feature vector for the unknown object to the stored feature vectors in the catalog to generate one or more candidate object labels further comprise instructions to generate a closeness matrix in which:
each row is a vector of closeness values of each view of the input object to a known object in the catalog; and
the closeness matrix has a number of rows or columns equal to the number of labeled objects in the catalog.

20. The system of claim 11, wherein:
the instructions to generate the one or more candidate object labels for the unknown object comprises instructions to generate an initial match hypothesis for the unknown object, wherein the initial match hypothesis comprises one of the known objects in the catalog; and
the instructions to cause the user interface to output at least one of the candidate object labels comprise instructions to:
display an image of a known object that corresponds to the initial match hypothesis, and
display images of a plurality of the known objects that are in a nearest neighbor network of the known object that corresponds to the initial match hypothesis.

21. A computer program product for classifying an object in a plurality of digital images, the product comprising a processor and a memory storing computer-readable instructions that, when executed, will cause the processor to:
receive a plurality of input images that include a plurality of views of an unknown object;
process the input images to generate a feature vector for the unknown object;
access a data store that includes a catalog that contains:
images of a plurality of known objects that comprise transportation infrastructure objects, and
for each known object, a feature vector that represents features from one or more views of the known object, and
compare the feature vector for the unknown object to the stored feature vectors in the catalog to generate one or more candidate labels for the unknown object;
output, via a user interface, an image of the unknown object and at least one of the candidate labels; and
select, from the candidate labels, a final label for the unknown object.
